(19) United States
(12) Patent Application Publication
(10) Pub. No.: US 2013/0232191 A1
(43) Pub. Date: Sep. 5, 2013

(54) Multi-Application Cloud Storage Platform and Cloud Storage Terminal

(71) Applicant: NETAC TECHNOLOGY CO., LTD., Shenzhen (CN)

(72) Inventors: Xiaohua Cheng, Shenzhen (CN); Saiwen LU, Shenzhen (CN)

(73) Assignee: NETAC TECHNOLOGY CO., LTD., Shenzhen (CN)

(21) Appl. No.: 13/769,506

(22) Filed: Feb. 18, 2013

(30) Foreign Application Priority Data
Mar. 2, 2012 (CN) 201210053550.0

(51) Int. Cl. H04L 29/06

(52) U.S. Cl. CPC H04L 67/42
USPC 709/203

(57) ABSTRACT

A client platform and a cloud storage terminal for cloud storage includes a client interface adapted to connect to a client terminal which is communicated with multiple cloud storage servers, multiple partitions corresponding to multiple cloud storage applications, in which there is a mapping relationship between the multiple partitions and the multiple cloud storage servers, a user interface configured to receive a user input and a control module configured to perform a first operation on at least one of the multiple partitions based on the user input.

This application claims the priority of Chinese Patent Application No. 201210053550.0, entitled “MULTI-APPLICATION CLOUD STORAGE PLATFORM AND CLOUD STORAGE TERMINAL”, filed with the Chinese Patent Office on Mar. 2, 2012, which is incorporated by reference in its entirety herein.

### FIELD OF THE INVENTION

The present application relates to cloud storage, and in particular to a multi-application cloud storage platform and cloud storage terminal for integrally manage various cloud storage products.

### BACKGROUND OF THE INVENTION

The cloud storage has been very popular with many manufactures since its concept was proposed. Products and solutions related to the cloud technology have been issued by the world's every major data and information supplier. However, consumers may not know how to choose a product from so many cloud products. It is desirable to have an application platform for integrally managing various cloud storage products.

### SUMMARY OF THE INVENTION

The present application is directed to provide a multi-application cloud storage platform and cloud storage terminal for integrally manage various cloud storage products.

According to one aspect of the present application, there is provided a client platform for cloud storage, which includes a user interface configured to receive a user input, a plurality of application modules related to a plurality of cloud storage servers which are connected to a client terminals, and a control module configured to perform a first operation on at least one of the plurality of application modules based on the user input. A cloud storage terminal with the client platform is further provided.

According to another aspect of the present application, there is provided a cloud storage terminal, which includes a client interface configured to connect to a client terminal communicated with a plurality of cloud storage servers; a plurality of partitions corresponding to a plurality of cloud storage applications, wherein there is a mapping relationship between the plurality of partitions and the plurality of cloud storage servers; a user interface configured to receive a user input; and a control module configured to perform a first operation on at least one of the plurality of partitions based on the user input.

According to the multi-application cloud storage platform and the cloud storage terminal of the present application, users may enjoy various cloud services at the same time and may conveniently choose, add or reduce various cloud services, by means of only one cloud storage terminal.

### BRIEF DESCRIPTION OF THE DRAWINGS

FIG. 1 shows a schematic block diagram of an architecture of a cloud storage system according to the present application;

FIG. 2 shows a schematic block diagram of an architecture of a cloud storage system according to an embodiment of the present application; and

FIG. 3 shows a schematic block diagram of an architecture of a cloud storage system according to another embodiment of the present application.

### DETAILED DESCRIPTION OF THE INVENTION

The technique solution of the present application will be described in the following with reference to an exemplary embodiment of the present application and in conjunction with the appended drawings.

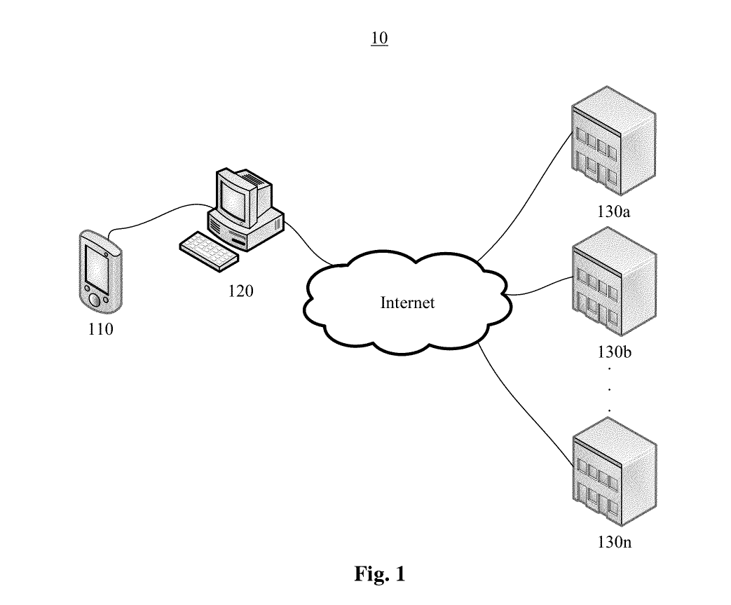

FIG. 1 shows a schematic block diagram of an architecture of a cloud storage system according to the present application. As shown in FIG. 1, a cloud storage system 10 according to the present application includes a cloud storage terminal 110, a client terminal 120 and a cloud storage server group including multiple cloud storage servers 130a, 130b . . . 130n. The cloud storage server is mainly adapted to store data. For example, data of files of multiple users may be stored on the cloud storage server 130. Multiple cloud storage servers are adapted to provide different services. For example, the cloud storage server group may include a Dropbox server, a SugarSync server, a Kanbox server or a Kingsoft fast-disk server and the like, and each of the servers may respectively correspond to a net disk.

The cloud storage terminal 110 can be connected to the client terminal 120 by way of a wired or wireless connection, for example, by way of a wired connection such as USB, eSATA and PC/SC, or by way of a wireless connection such as WIFI and WIMAX. The cloud storage terminal 110 is adapted to provide an identity authentication function and an application storage function for various applications. For example, the cloud storage terminal 110 may be a flash disk with an identity authentication function, a mobile hard disk, an SD card, an intelligent card or a cell phone. The client terminal 120 is configured to be capable of running a client software and establishing a connection with the cloud storage terminal and the cloud storage server group by way of, for example, Ethernet or WIMAX. The client terminal integrally manages various applications by running the client software. A typical client terminal may be for example a PC or a hand-hold terminal such as a cell phone and a panel computer.

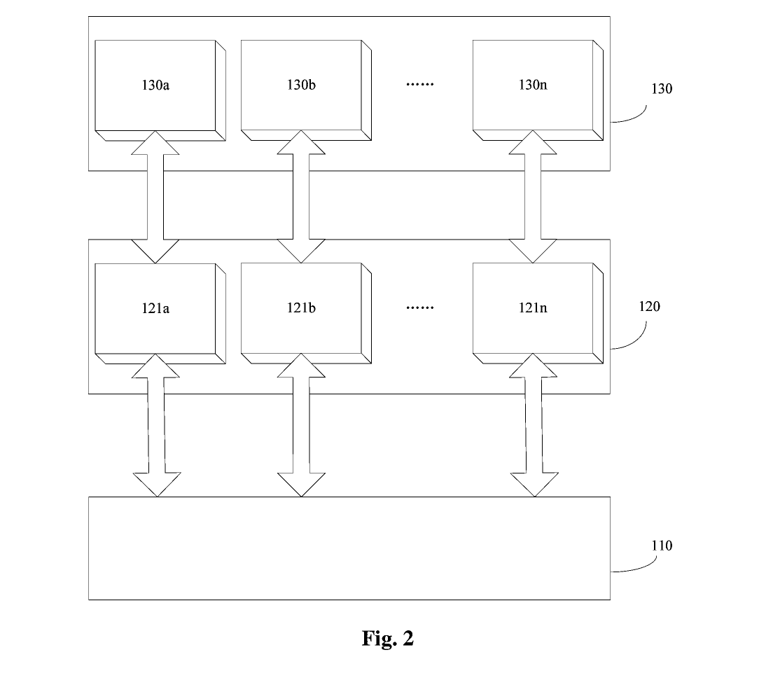

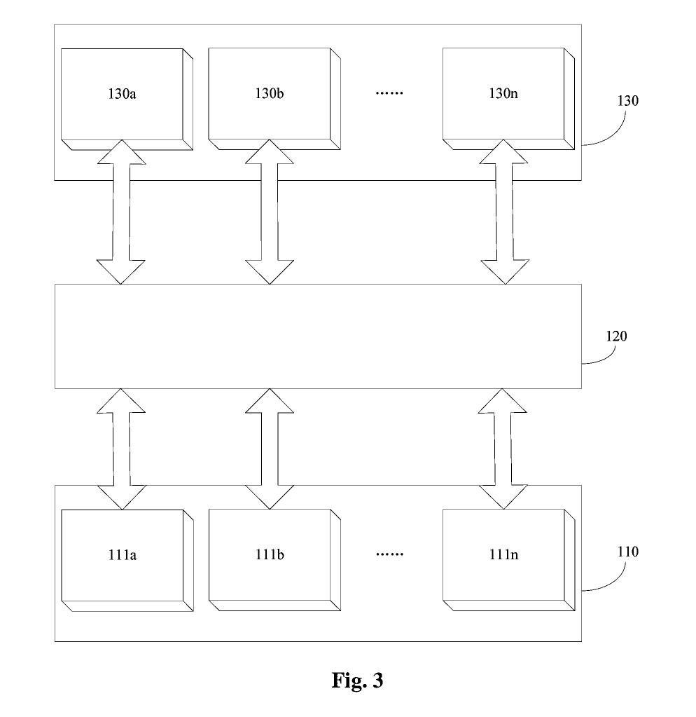

According to the present application, there are provided two architectures corresponding to the above system to function as an integral management of multi-application. The two architectures are described respectively with reference to FIG. 2 and FIG. 3 and in conjunction with exemplary embodiments.

FIG. 2 shows a schematic block diagram of an architecture of a cloud storage system for the multi-application management according to an embodiment of the present application. As shown in the figure, a cloud storage server group 130 includes multiple cloud storage servers 130a, 130b . . . 130n. Multiple applications 121a, 121b . . . 121n are integrated in the client software which runs on the client terminal 120, and each of the applications is related to a corresponding server respectively. After being connected to the client 120, the cloud storage terminal 110 runs the client software to display various available applications. A user may manage the various applications as required. For example, the user may choose one application to manage files (such as upload or download), delete one or more existing applications, or add one or more new applications. The addition and deletion of applications may be configured by the user as required. After an application to be used is chosen, the corresponding application is invoked and performed by the client software to provide various services for the user. Thus, it is achieved to provide different services from multiple suppliers or one supplier to the user in one platform.

According to this embodiment, there is provided a client platform (client software) for cloud storage, which includes a user interface (not shown) configured to receive a user input, multiple application modules 121a, 121b . . . 121n related to multiple cloud storage servers which are connectable with a client terminal respectively, and a control module (not shown) configured to perform a first operation, such as selecting, adding, deleting or updating, for at least one of the multiple application modules based on the user input. The user may also add, reduce or update an application in the client software by upgrading the client software.

In the case that the first operation is to select at least one of the multiple application modules, the control module is further configured to activate the selected application module based on a subsequent user input, and to perform a second operation related to a corresponding cloud storage server among the multiple cloud storage servers via the application module. The second operation may be an operation related to the cloud storage and be performed on a file. For example, the second operation may be an operation for uploading a file to the corresponding cloud storage server or downloading a file from the corresponding cloud storage server.

According to the present application, the client platform may be stored on a cloud storage terminal or a client terminal.

Although the client platform is shown as being stored on the client terminal in FIG. 2 for clarity, the client platform is stored preferably on a cloud storage terminal. In this case, the client platform can be operated only if the cloud storage terminal is connected to the client terminal, so as to ensure the data security. Therefore, the present application further provides a cloud storage terminal including the above-mentioned client platform.

Optionally, the client software may also be stored on a network server and be upgraded via the network. The client software can perform a corresponding function when being downloaded and run on a client.

FIG. 3 shows a schematic block diagram of an architecture of a cloud storage system according to another embodiment of the present application.

According to this embodiment, the cloud storage terminal 110 implements an integral multi-application management by providing an independent storage space for each of services provided by servers. For example, multiple partitions are divided or multiple file folders are created on the cloud storage terminal 110, in which each of the partitions or file folders corresponds to different applications (for example, corresponds to different net disks). There is a mapping relationship between the multiple partitions or file folders and the multiple cloud storage servers corresponding to the multiple applications.

A client terminal displays the multiple disk symbol or file folders corresponding to the multiple partitions or file folders when the cloud storage terminal is connected to the client terminal. When a certain partition or file folder is operated by a user, the cloud storage terminal analyzes the user operation to determine which service is needed by the user and establishes a connection with the corresponding server, so as to perform an interaction. In this case, the client terminal only needs to provide a public API interface which can be invoked by the multiple cloud storage servers, so that the cloud storage servers can access to the corresponding partitions or file folders via the API interface provided by the client terminal.

The cloud storage terminal according to this embodiment includes a client interface configured to connect to a client terminal which can be communicated with multiple cloud storage servers; multiple partitions corresponding to multiple cloud storage applications in which there is a mapping relationship between the multiple partitions and the multiple cloud storage servers; a user interface configured to receive a user input; a control module configured to perform a first operation on at least one of the multiple partitions based on the user input. The first operation may be to open, close, select, add, delete or update at least one of the multiple partitions, for example. In the case that the first operation is to select at least one of the multiple partitions, the control module is further configured to perform a second operation related to a corresponding cloud storage server among the multiple cloud storage servers on the selected partition based on a subsequent user input. The second operation may be an operation related to the cloud storage and be performed on a file, such as an operation for uploading a file to the corresponding cloud storage server or an operation for downloading, deleting, or updating a file from the corresponding cloud storage server.

According to this embodiment, the multiple cloud storage servers establish connections with the clients and the cloud storage terminals via the provided public API interface. In the case that an application needs to be added, a independent storage space is provided for the new application by the cloud storage terminal by way of, for example, adding a dedicated partition or creating a dedicated file folder. Then, a mapping relationship between the independent storage space and the new cloud storage server may be established by the cloud storage terminal or the client software, and thereby the cloud storage terminal may connect to the corresponding server when the partition or the file folder is operated by a user.

For the existing services, the user may choose to open or close some of them by a configuration. For example, although there are already three partitions corresponding respectively to a Kanbox cool-disk, a Kingsoft fast-disk, and a Netac net-disk on a cloud storage terminal, the user only wants to use the Netac net-disk, and then the user may choose to close the services of the Kanbox cool-disk and the Kingsoft fast-disk by the configuration. Only the partition corresponding to the Netac net-disk is displayed to the user on the cloud storage terminal after the configuration is in effect. In this way, the user operations are clear and a mistake can be avoided.

The present application is described above with reference to the accompanying drawings and in conjunction with the embodiments. It should be understood that the above-mentioned embodiments are only exemplary and do not limit the present application. Various proper changes or modifications may be made to the above-mentioned embodiments by those skilled in the art without departing from the spirit and scope of the present application.

1. A client platform for cloud storage, comprising:
a user interface configured to receive a user input;
a plurality of application modules related to a plurality of cloud storage servers which are connected to a client terminal; and
a control module configured to perform a first operation on at least one of the plurality of application modules based on the user input.

2. The client platform according to claim 1, wherein the client platform is stored on a cloud storage terminal and configured to operate in the case that the cloud storage terminal is connect to the client terminal.

3. The client platform according to claim 2, wherein the first operation is an operation for opening, closing, selecting, deleting or updating at least one of the plurality of application modules, or an operation for adding one or more new application modules.

4. The client platform according to claim 3, wherein in the case that the first operation is the operation for selecting at least one of the plurality of application modules, the control module is further configured to perform a second operation related to a corresponding cloud storage server among the plurality of cloud storage servers by using the selected application module based on a subsequent user input.

5. The client platform according to claim 4, wherein the second operation is an operation related to the cloud storage and is performed on a file.

6. A cloud storage terminal, comprising a client platform for cloud storage, wherein the client platform comprises
a user interface configured to receive a user input;
a plurality of application modules related to a plurality of cloud storage servers which are connected to a client terminal; and
a control module configured to perform a first operation on at least one of the plurality of application modules based on the user input.

7. The cloud storage terminal according to claim 6, wherein the client platform is stored on a cloud storage terminal and configured to operate in the case that the cloud storage terminal is connect to the client terminal.

8. The cloud storage terminal according to claim 7, wherein the first operation is an operation for opening, closing, selecting, deleting or updating at least one of the plurality of application modules, or an operation for adding one or more new application modules.

9. The cloud storage terminal according to claim 8, wherein in the case that the first operation is the operation for selecting at least one of the plurality of application modules, the control module is further configured to perform a second operation related to a corresponding cloud storage server among the plurality of cloud storage servers by using the selected application module based on a subsequent user input.

10. The cloud storage terminal according to claim 9, wherein the second operation is an operation related to the cloud storage and is performed on a file.

11. A cloud storage terminal, comprising:
a client interface adapted to connect to a client terminal which is communicated with a plurality of cloud storage servers;
a plurality of partitions corresponding to a plurality of cloud storage applications, wherein there is a mapping relationship between the plurality of partitions and the plurality of cloud storage servers;
a user interface configured to receive a user input; and
a control module configured to perform a first operation on at least one of the plurality of partitions based on the user input.

12. The terminal according to claim 11, wherein the first operation is an operation for opening, closing, selecting, deleting or updating at least one of the plurality of partitions, or an operation for adding one or more new partitions.

13. The terminal according to claim 12, wherein in the case that the first operation is an operation for selecting at least one of the plurality of partitions, the control module is further configured to perform a second operation related to a corresponding cloud storage server among the plurality of cloud storage servers on the selected partition based on a subsequent user input.

14. The terminal according to claim 13, wherein the second operation is an operation related to cloud storage and is performed on a file.
